(19) United States
(12) Patent Application Publication
(10) Pub. No.: US 2002/0166288 A1
(43) Pub. Date: Nov. 14, 2002

(54) Anti-entrapment device for cable-driven window lifting mechanism

(76) Inventor: Yann LeGallo, Orleans (FR)

Correspondence Address: CARLSON, GASKEY & OLDS, P.C., 400 WEST MAPLE ROAD, SUITE 350, BIRMINGHAM, MI, 48009, US

(21) Appl. No.: 10/092,363

(22) Filed: Mar. 5, 2002

(30) Foreign Application Priority Data
Mar. 7, 2001 (FR) 01 03104

(51) Int. Cl. E05F 11/48

(52) U.S. Cl. 49/352

(57) ABSTRACT

A vehicle window glass lifting mechanism comprises a sliding member for a window glass, a cable for driving the sliding member. The cable is connected to the sliding member and a motor drives the cable. The window glass lifting mechanism comprises a sensor for measuring tension in the cable. The mechanism allows measurement of the mechanical stress in one of its parts. This measurement is represented by the tension exercised on a window glass drive cable, to be measured without delay. Entrapment of an object is determined by detecting an increase in cable tension, detection being rapid and allowing limitation of a force exercised on an object trapped by the window glass. A method for determining entrapment by a window glass is also provided consisting in measuring the tension in a window glass drive cable, comparing the measured tension with an entrapment threshold and determining an object is trapped when the measured tension exceeds this threshold. The device and method can for example be used to stop or reverse the drive of the cable by an electric motor.

### BACKGROUND OF THE INVENTION

The invention relates to an anti-entrapment device for a window lifting mechanism and more particularly for motor-driven cable-operated vehicle window lifting mechanisms.

Window glass lifting mechanisms are most frequently driven by electric motors. It can happen that an object or person's hand gets accidentally placed in the path of the rising window and gets trapped between the top of the window and the vehicle door frame, which can give rise to various types of damage or injury. Various devices are known for stopping the movement of the window or for causing it to be lowered again.

Thus, U.S. Pat. No. 5,296,658 uses window seals containing capacitors or optical fibres. The seal characteristics are modified when an object gets trapped, which supplies an entrapment signal that operates on the window drive. However, such seals are, firstly, expensive and secondly, have little aesthetic appeal as they are bulky and plainly visible.

U.S. Pat. No. 6,086,177, German Patents 3,034,114 and 4,442,171 disclose information measures concerning the drive motor for detecting entrapment. German patent 3,034,114 proposes measuring the speed of rotation of the electric motor, German Patent 4,442,171 proposes measuring electric motor current and U.S. Pat. No. 6,086,177 proposes measuring another motor characteristic. Some change in the measured information makes it possible to determine than an object is trapped. However, such methods have disadvantages. In view of the characteristics of the electric motor, notably its inertia, resistance or flux, a fairly high response time between an object getting entrapped and its detection exists. Response time is typically of the order of 25 ms. The window glass drive force can in the meantime substantially increase and lead to injury. The entrapment force can also exceed the threshold values defined in the relevant standards, which makes it difficult to get vehicle roadworthiness approval.

It is also known to perform processing of the measured information in order to compensate for this response time. However, the electronic components employed for such processing have characteristics subject to drift as they start to age. A considerable response time can then reappear.

### SUMMARY OF THE INVENTION

There is consequently a need for a window lifting mechanism that resolves one or several of these disadvantages. Thus, the invention discloses a window glass lifting mechanism comprising:

a sliding member or slider for a window glass;

a cable for driving the sliding member for a window glass, connected to the sliding member;

a motor for driving the cable;

a sensor measuring tension in the cable.

The sensor preferably is provided at the sliding member and measures the force exercised by the cable on the sliding member.

The cable can have an end stop for the sliding member drive, the sensor being arranged between the end stop and the sliding member.

In an embodiment, the window lifting mechanism further comprises two end stops, a flexible and non-compressible sheath provided between the two end stops and at least partially surrounding the cable, the sensor measuring the axial force exercised by the cable on the sheath.

In an alternative embodiment, the sensor is arranged between an end stop and one end of the sheath. In another alternative, the sensor is a pressure sensor.

In another embodiment, the window glass lifting mechanism further comprises:

two end stops;

a flexible and non-compressible sheath provided between the two end stops and at least partially surrounding the cable;

a spring arranged between an end stop end one end of the sheath;

the sensor measuring the position of the end of the sheath.

In a particular window glass lifting mechanism, the motor comprises a housing. In an alternative window glass lifting mechanism, the sensor is a switch and the sensor is fixed to one of either the end of the sheath or the motor housing, the window glass lifting mechanism further comprises an actuator fixed on the other of the end of the sheath or the motor housing, and the actuator faces the switch, and the actuator actuates the switch when a predetermined cable tension is reached. The switch can provide a signal whose amplitude is almost proportional to the distance between the end of the sheath and the corresponding end stop. The switch can also provide an entrapment signal when a predetermined cable tension is reached.

According to an alternative, either the end of the sheath or the motor housing provide a metallic portion and the sensor is an Hall effect sensor arranged on the other of the end of the sheath or the motor housing, proximate to the metallic portion.

The window glass lifting mechanism can further comprise a processing module linked to the sensor and supplying a signal representing a trapping by the window glass lifting mechanism.

A method for determining entrapment by a window glass lifting mechanism is also provided consisting in:

measuring a tension in a window glass lifting sliding member drive cable;

comparing the measured tension with an entrapment threshold;

supplying a signal representing entrapment by the window glass lifting mechanism when the measured tension exceeds the threshold value.

The method can further comprise:

storing in a memory for the window glass lifting mechanism a reference value as a function of a parameter such as an entrapment threshold;

measuring a tension in the window glass lifting cable as a function of that parameter;

comparing the measured tension with the reference value for a given parameter value.

The value stored in memory can be a function of a cable tension measured during an earlier window glass lifting cycle.

The value stored in memory can also take account of a cable tension measured during several earlier window glass lifting cycles.

Further characteristics and advantages of the invention will become more clear from the description which follows of some embodiments thereof provided by way of example and with reference to the attached drawings.

### BRIEF DESCRIPTION OF THE DRAWINGS

FIG. 1 is a front view of a window lifting mechanism according to a first embodiment of the invention.

FIG. 2 shows a tension measuring device on a larger scale.

FIG. 3 shows a second embodiment of a tension measuring device on a larger scale.

FIG. 4 shows details of another embodiment of a window glass lifting mechanism using switch sensor;

FIG. 5 shows details of an embodiment using a linear potentiometer as a sensor;

FIG. 6 shows an embodiment using a hall effect sensor;

FIG. 7 is a graph showing a cable reference tension and cable tension when an object becomes trapped.

FIG. 8 is a graph showing a stored cable reference tension and cable tension when an object becomes trapped.

### DETAILED DESCRIPTION OF THE INVENTION

The invention proposes measuring, without phase shift, mechanical tension of a window lifting mechanism part, represented by the tension exercised on a window drive cable.

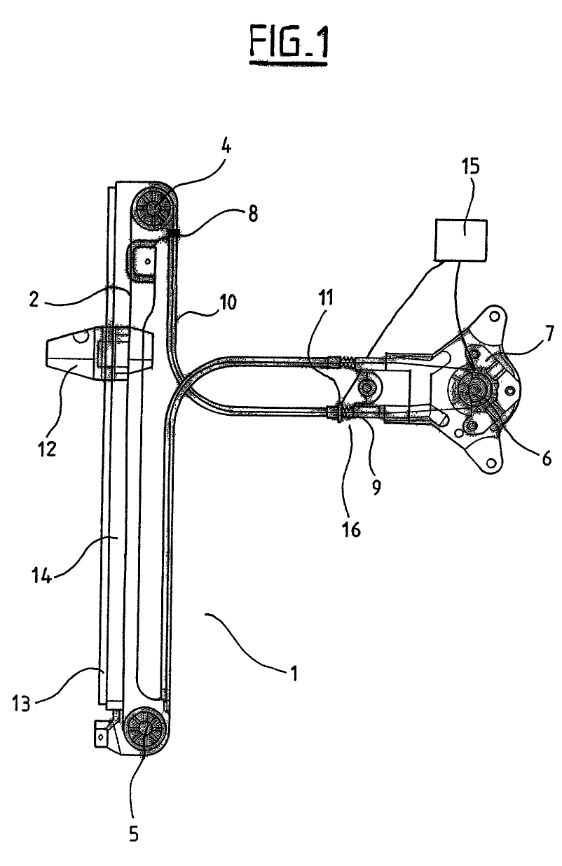

FIG. 1 shows a window lifting mechanism 1 in a first embodiment of the invention. This window lifting mechanism 1 is preferably located inside a vehicle door. The window lifting mechanism has a cable 2 connected to a window glass, not shown, via a slide member. The slide member is arranged between an upper direction-changing pulley 4 and a lower direction-changing pulley 5. The cable passes over the direction changing pulleys 4 and 5 and makes a loop by passing over the drive pulley 6 of a motor 7, which is not illustrated in detail. Two fixed end stops 8, 9 are located on the path of cable 2, between motor 7 and the upper direction-changing pulley 4. Cable 2 is surrounded by a sheath 10 between the stop members 8 and 9. Sheath 10 has a first end in contact with the first stop member 8. A sensor 11, for example a pressure sensor, is inserted between the second end of the sheath 10 and the second stop member 9. The sheath 10 keeps the cable 2 in a curved position.

Preferably, a slide member 12 is used for connecting the window glass to the cable. The slide member is for example secured by crimping on drive cable 2. When the slide member 12 is secured to cable 2, this transmits a drive force for lowering and raising the window glass. The slide member 12 is secured to the window glass by any suitable means, for example by bonding or screwing. The securing of slide member 12 on the window glass makes it possible to transmit a drive force for lowering and raising the window.

A rail 13 for guiding the movement of slide member 12 can be provided. This ensures the window glass is raised and lowered without going off course. This ensures for example that seals located between the window glass and the vehicle door are not compressed or damaged. One can also provide for the window glass to be directly guided by rail 13.

Below, we shall call the upper cable run that part of the cable 2 that starts from motor 7 and drives the window glass when it is being raised. The cable run is designed to drive the glass during its raising movement. This cable run passes over an upper direction-changing pulley 4. This pulley 4 acts as a point of support for modifying the path of this run of cable 2. Thus, even if the upper cable run originates from a location lower down on the door, the path is redirected so as to drive the window glass upwards. This pulley 4 is pivotally mounted with respect to the vehicle, so as to limit friction between the cable 2 and the pulley 4. This reduces cable wear. Pulley 4 is preferably mounted on a structural component 14 secured to the vehicle door. Guide rail 13 can also be provided in this structural part 14.

The upper cable run then extends between the upper direction changing pulley 4 and a pulley 6 of drive motor 7. A first stop member 8 is provided on the path of the cable 2 close to direction changing pulley 4. This end stop 8 is preferably secured to the structural part 14. A second stop member 9 is also arranged on the cable path, close to motor 7. This stop member 9 is preferably integral with the vehicle door or motor body.

A sheath 10 surrounds the major portion of the upper cable run between the stop members 8 and 9. The stop members 8, 9 allow a maintaining force to be exercised directly or indirectly on the ends of sheath 10. Sheath 10 exercises a force having a bending effect on the upper cable run. Thus, when the upper cable run is under tension, this upper cable run sets up a reaction force in sheath 10. A non-compressible sheath is preferably employed. Forces in the sheath 10 and, notably, the axial compression of sheath 10 are now representative of the tension in cable 2. It is possible to keep sheath 10 in a curved position by for example using a sheath 10 which is longer than the distance between the stop members 8 and 9. It is then preferable to employ a flexible sheath, so as to be able to establish curvature of the cable 2. This curvature is then also variable as a function of the tension exercised on the cable.

Sheath 10 has a first portion in contact with stop member 8. A pressure sensor 11 is inserted between the second cable end and stop member 9. Similarly, one can envisage inserting sensor 11 between the first end of the sheath and stop member 8. Generally speaking, any sensor that can measure a force between sheath 10 and a fixed point, or measure axial compression of sheath 10, is suitable. Any suitable type of sensor can be selected for measuring the forces in the sheath, for example a piezoelectric sensor or a strain gauge. This pressure sensor 11 can for example deliver a signal indicating the pressure or force that the sheath is exercising on it, via a processing module 15. In one embodiment, processing module 15 is adapted to command drive motor 7. One example of the operation of a processing module 15 will be described in detail below.

In one embodiment, a spring 16 is inserted between pressure sensor 11 and stop member 9. This spring 16 can also be inserted between pressure sensor 11 and the second end of the sheath 10. This spring 16 has the effect of taking up slack in the sheath 10. The sheath 10 transmits this force to the upper run of cable 2. Thus, the cable 2 is kept at a tension higher than a determined threshold level during operation of the window lifting mechanism. This avoids jerks when the window glass is being raised or when changing over from lowering it to raising it. It is preferable to use a compression spring dimensioned so that the turns come into contact during a stabilized raising operation of the window glass.

The pressure exercised by the sheath 10 on the sensor 11 may not be uniform as a result of the shape of the spring 16 or a tendency for the curved sheath 10 to turn or pivot. It is consequently preferable to arrange a washer 20 between the sheath 10 and the sensor 11 or between the spring 16 and the sensor 11. This distributes pressure over the sensor to give a more reliable measurement. The washer 20 or washers are advantageously integral with the end of the sheath 10, the spring 16 or pressure sensor 11. This facilitates assembly of the window lifting mechanism.

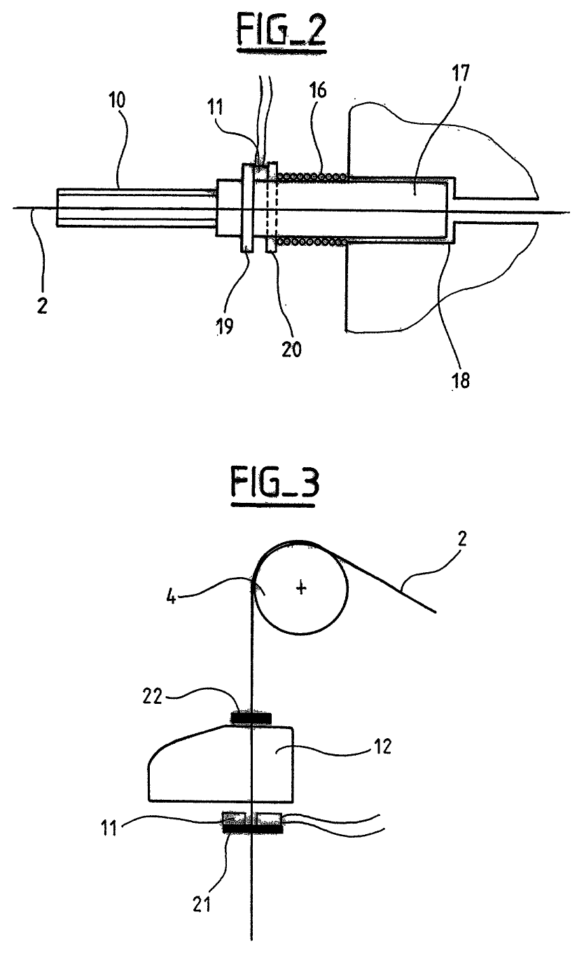

In the embodiment shown in FIG. 2, one end of the sheath has an elongated pipe 17. This pipe 17 is designed to be inserted into a passage in stop member 9. Pipe 17 and passage 18 co-operate to prevent sheath 10 pivoting or turning with respect to stop member 9. A radius of curvature for the cable 2 sufficiently large is obtained to avoid deterioration of the latter during use. Pipe 17 may include a shoulder 19 designed to abut against the pressure sensor 11. This shoulder advantageously avoids having to place an additional washer 20 between the end of the sheath 10 and the sensor 11. Passage 18 is in this case arranged to be sufficiently deep for the sensor 10 to get compressed between the shoulder and stop member 9. Pipe 17 is then inserted sufficiently deeply into the passage to ensure the sensor 11 gets compressed without encountering some possible end stop provided in the passage.

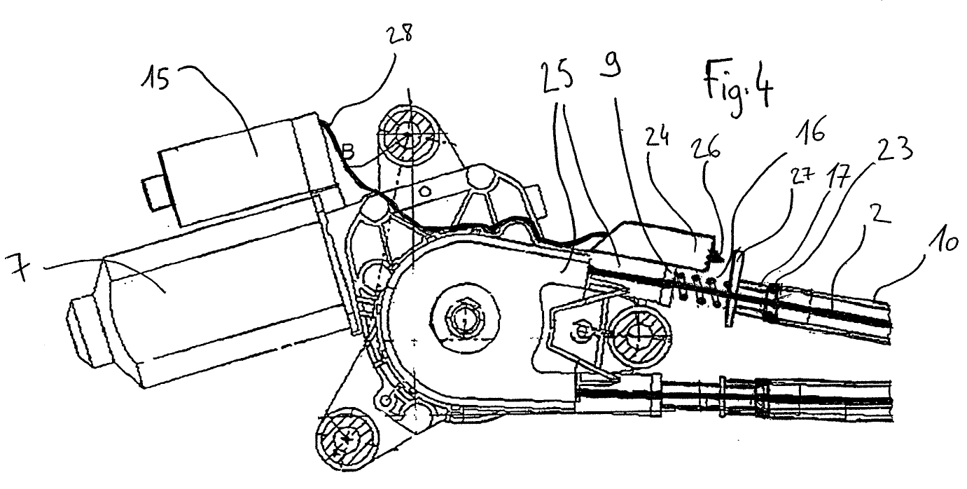

FIG. 3 shows another embodiment of a window lifting mechanism according to the invention. One end stop 21 for rising travel of a window glass is secured onto cable 2, for example by crimping. One can for example use a cable end as the stop member 21 for raising travel of the window glass. A sensor 11, for example a pressure sensor, is located above end stop 21. A securing member for the window glass, for example a slide member 12, is slidably mounted with respect to the cable and comes into abutment with pressure sensor 11. During rising travel of the window glass, sensor 11 gets compressed between the rising travel end stop 21 and the part secured to the window glass. Sensor 11 thus allows the drive force in the cable to be determined. It can also be arranged to provide an end stop for lowering travel 22 on the cable 2 driving the part secured to the window glass.

FIG. 4 shows another possible embodiment for the window glass lifting-mechanism. The window glass lifting-mechanism provides two end stops and a flexible and non-compressible sheath 10 arranged between the end stops. Sheath 10 surrounds cable 2. A helical spring 16 is arranged between end stop 9 and an end 23 of the sheath 10. Thus, the spring 16 is deflected according to the tension applied on the cable. The position of the end 23 of the sheath is modified accordingly. The window glass lifting-mechanism provides a sensor 24 for measuring the position of said end of the sheath 10.

In the example of FIG. 4, the motor comprises a housing 25 supporting the end stop 9. Sensor 24 is obtained by using a switch. The switch provides a protruding pushbutton 26. An actuator 27 is maintained between sheath end 23 and said spring 16. The actuator position thus varies according to the spring 16 deflection. When a predetermined cable tension is applied, the spring 16 is deflected by a certain amount. At that point, the actuator 27 abuts against the pushbutton 26. The actuator 27 thus actuates the pushbutton when the cable tension exceeds a predetermined level. The switch 24 delivers a corresponding signal through wires 28 to an electronic processing module 15. The signal can be treated as an entrapment signal. One could also use this signal as a direct stop command for motor 7.

The respective arrangement of actuator 27 and switch 24 could also be reversed. One could also consider arranging a switch fixed relative to the sheath end 23, designed to abut on an end stop of the housing 25 above a predetermined cable tension. The housing end stop is then used as an actuator.

The end of the sheath can also provide an elongated pipe 17 as in the embodiment of FIG. 2. This pipe can present a similar structure and functions as the one of FIG. 2. The actuator 27 can be fixed on the pipe 17 or be realised as a single unit with pipe 17. The actuator can also be interposed between spring 16 and pipe 17.

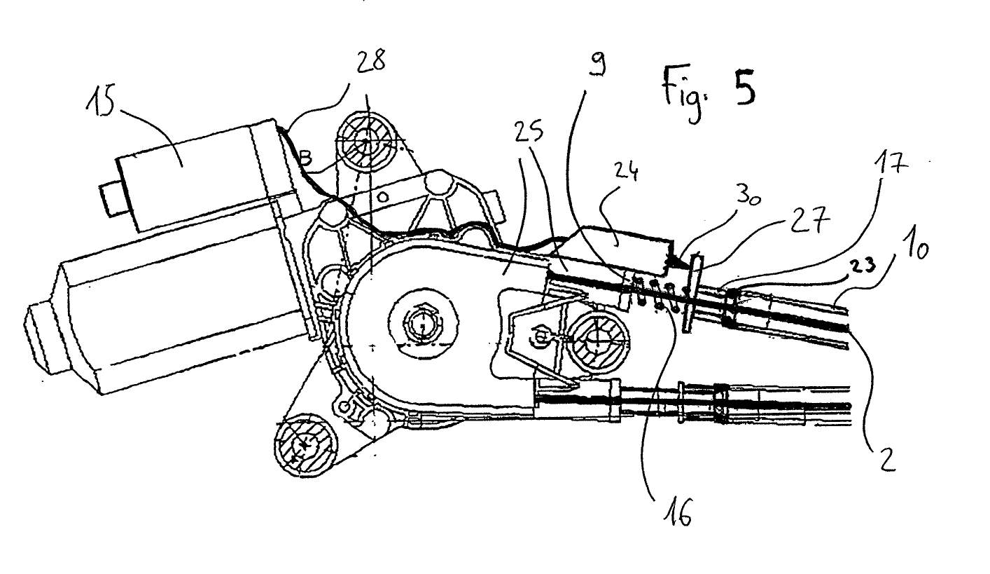

In an alternative embodiment shown at FIG. 5, sensor 24 is obtained by using a linear potentiometer. An actuator 27 actuates a pushbutton 30. One can use an actuator 27 with a structure similar to that used in FIG. 4. The deflection of the pushbutton is in that case proportional to the deflection of spring 16. The linear potentiometer 24 can thus provide a signal whose amplitude is almost proportional to the distance between the end of the sheath 23 and the corresponding end stop. The cable tension can thus be derived from the linear potentiometer used as a position sensor.

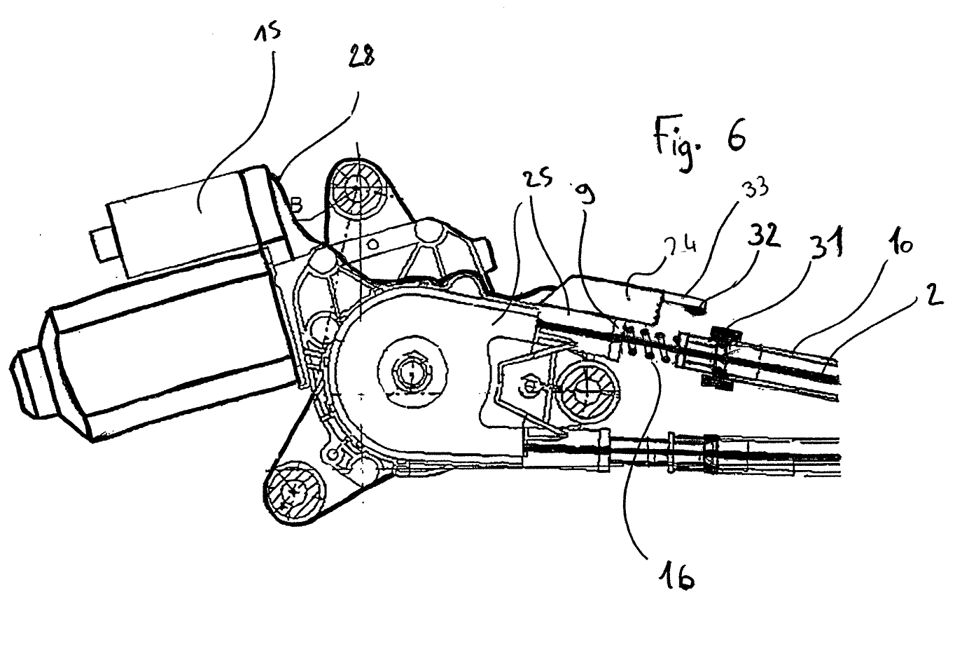

FIG. 6 shows a further embodiment of the window glass lifting mechanism. Sensor 24 provides a protrusion 33. A Hall effect sensor 32 is arranged at the end of the protrusion 33. The Hall effect sensor is located appropriately to overhang the end of the cable sheath 10. The end of the cable sheath 10 is able to slide relative to the Hall effect sensor 32 upon a deflection of spring 16. A metallic portion is arranged at the end 23 of the sheath 10. In the example, this metallic portion is an annular metallic ring located between a pipe 17 and the sheath end 23. The amplitude of the signal generated by sensor 32 varies depending on the relative positions of sensor 32 and metallic ring 31. The relative positioning of sensor 32 and of metallic ring 31 is preferably chosen such that the signal generated by sensor 32 reaches an extreme value when the relative position corresponds to an entrapment cable tension. The signal generated by the Hall effect sensor can be compared to an entrapment reference value in sensor 24 or in the electronic processing module 15. The relative distance between sensor 32 and metallic ring 31 is appropriately set in order to generate a signal with sufficient amplitude to distinguish an entrapment.

In an alternative embodiment, the relative position of sensor 32 and metallic ring 31 is such that the signal generated by the sensor is almost proportional to the spring deflection. Obviously one could also use another metallic device to generate the signal of sensor 32. One could also design a window glass lifting mechanism in which the metallic portion is arranged on a fixed part and the sensor is fixed relative to sheath end 23.

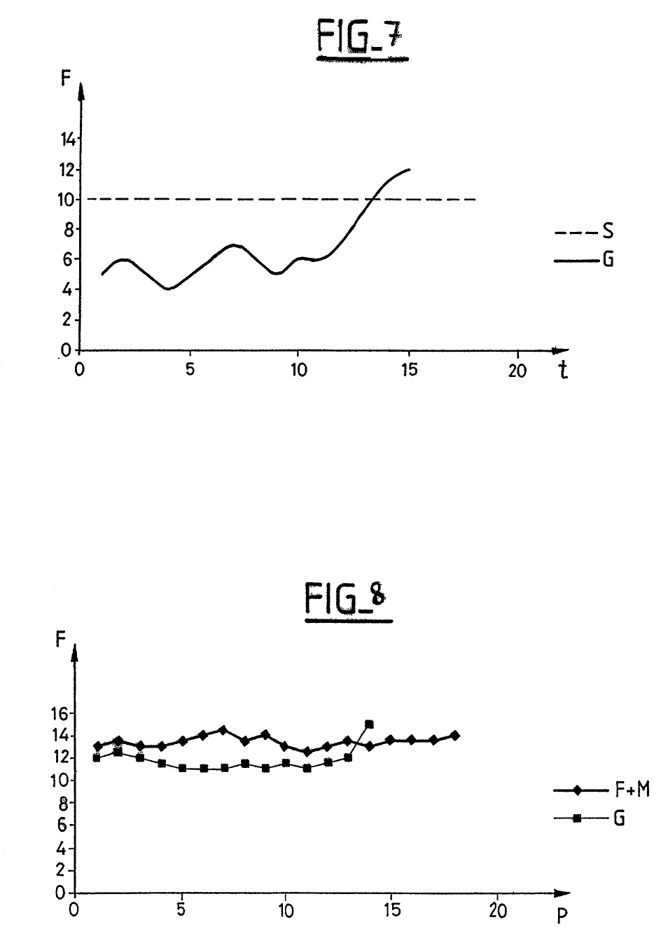

Signals output from the sensor can be delivered to processing module 15. This processing module receives the signals at an input connected to the sensor. This processing module may include a comparator which compares the signal measured by the sensor which for example represents tension in the cable with a predetermined threshold value as illustrated in FIG. 7. When a signal measured G exceeds threshold value S, the processing module concludes that an object is trapped and prevents the window rising further. The processing module can now send a corresponding signal to a central computer or act directly on the drive motor. Processing module 15 can for example be directly connected to a switch on a motor to stop lifting or lowering of a window glass. As tension is measured on a mechanical part having no or extremely reduced phase shift due to processing by module 15, the measurement performed at any given instant corresponds approximately to the force exercised on the upper cable run at that instant.

According to the invention, another method of operation of a processing module allows account to be taken of the window glass position for determining entrapment. Reference measurement values corresponding to given positions of the window glass are for example stored in memory. These values correspond to thresholds for determining entrapment. The signal measured by the sensor is sampled for corresponding positions of the window glass. The sampling step can for example be 2 mm. This step can also be variable depending on window glass position. One can for example use a smaller sampling step for the final travel of the window glass. One can simultaneously measure the position of a window glass by for example measuring position on the electric motor or on a window glass slide member. For each position, the value measured when the window glass is being raised is compared with a corresponding reference entrapment threshold. When the value measured exceeds this threshold, the processing module concludes that an object is trapped and stops the window being raised. It is also possible to sample the measured values as a function of time. Here, at given time intervals, a value measured when the window glass is being raised is compared with a corresponding entrapment reference threshold.

In one embodiment, account is taken of previous window glass lifting cycles for setting an entrapment threshold. One can thus use a memory that can be rewritten for storing values measured over one or several previous cycles at determined positions. During a window glass lifting cycle, the measured signals are compared with the corresponding stored values after adding a margin for error to the stored values. One can for example employ the following inequality for determining trapping:

G(p)>F(p)+M [symbol] detection of entrapment,

where G is a signal measured by sensor 11, F is a value stored in memory, p is the window glass position and M is the error margin. As seen above, a signal measured by the sensor can be compared at a given instant with a corresponding value for F at that instant.

FIG. 8 shows values for F+M compared to values for G for corresponding positions p. It will be seen that the value for G is greater than F+M for the fourteenth sample. Thus, module 15 determines that an object is trapped.

It is clearly possible to store in memory the value for a signal measured during a cycle, incremented by the error margin. This method allows account to be taken of ageing of the window lifting mechanism components. This helps avoid undesired shutting down of the window lifting mechanism due to erroneous entrapment detections.

In one embodiment, several measurements for earlier cycles are stored in memory. A threshold is then determined by applying weighting factors to the measured values over the cycles. One can for example use the following equation for determining a threshold:

S(p)=(0.6*F₋₁(p)+0.4*F₋₂(p))+M

in which S is the determined trapping threshold, F₋₁ the value measured at the previous cycle, F₋₂ the value for the last cycle but one, p the position of the window glass and M the margin for error.

Thus, several cycles are taken into account when determining the threshold. The influence of an earlier cycle performed under particular conditions such as a very low temperature consequently has less influence on entrapment threshold determination.

Obviously, the present invention is not limited to the examples and embodiments described and illustrated but may be subject to numerous variations available to those skilled in the art. One can thus also provide means for measuring forces on the drive cable when the window glass is being lowered, for avoiding, for example, an object getting trapped between a door seal and the window glass. The location of the sensor is also not limited to those locations described. It is also possible to provide a force-detecting sensor on another element of the window lifting mechanism, for example on a direction changing pulley, for determining the cable drive tension.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. A window glass lifting mechanism comprising:
a sliding member for a window glass;
a cable for driving the sliding member for the window glass and connected to the sliding member;
a motor for driving the cable; and
a sensor measuring tension in said cable.

2. The window glass lifting mechanism according to claim 1, wherein the sensor is provided at the sliding member and measures the force exercised by the cable on the sliding member.

3. The window glass lifting mechanism according to claim 2, wherein the cable has an end stop for the sliding member drive, the sensor being arranged between the end stop and the sliding member.

4. The window glass lifting mechanism according to claim 1, wherein the window glass lifter mechanism further comprises a processing module linked to the sensor and supplying a signal representing trapping by the window glass lifting mechanism.

5. A window glass lifting mechanism comprising:
a sliding member for a window glass;
a cable for driving the sliding member for the window glass and connected to the sliding member;
a motor for driving the cable;
a sensor measuring tension in said cable;
a pair of end stops;
a flexible and non-compressible sheath provided between the pair of end stops and at least partially surrounding the cable;
said sensor measuring the axial force exercised by the cable on the sheath.

6. The window glass lifting mechanism of claim 5, wherein the sensor is arranged between an end stop and one end of the sheath.

7. The window glass lifting mechanism according to claim 6, wherein the sensor is a pressure sensor.

8. The window glass lifting mechanism according to claim 7, wherein the window glass lifting mechanism further comprises a processing module linked to the sensor and supplying a signal representing trapping by the window glass lifting mechanism.

9. A window glass lifting mechanism comprising:
a sliding member for a window glass;
a cable for driving the sliding member for the window glass and connected to the sliding member;
a motor for driving the cable;
a sensor measuring tension in said cable;
a pair of end stops;
a flexible and non-compressible sheath provided between the pair of end stops and at least partially surrounding the cable;
a spring arranged between one of said end stops and an end of the sheath; and
said sensor measuring the position of said end of the sheath.

10. The window glass lifting mechanism according to claim 9, wherein the motor comprises a housing.

11. The window glass lifting mechanism according to claim 10, wherein
the sensor is a switch, and the sensor is fixed to either one of said end of the sheath and the motor housing;
the window glass lifting mechanism further comprising an actuator fixed on the other of said end of the sheath and the motor housing, and the actuator faces the switch; and
the actuator actuates the switch when a predetermined cable tension is reached.

12. The window glass lifting mechanism according to claim 11, wherein the switch provides a signal having an amplitude almost proportional to the distance between said end of the sheath and the corresponding end stop.

13. The window glass lifting mechanism according to claim 11, wherein the switch provides an entrapment signal when a predetermined cable tension is reached.

14. The window glass lifting mechanism according to claim 10, wherein:
one of said end of the sheath and said motor housing provides a metallic portion; and
the sensor is a Hall effect sensor arranged on the other of said end of the sheath and said motor housing and proximate to the metallic portion.

15. The window glass lifting mechanism according to claim 9, wherein the window lift mechanism further comprises a processing module linked to the sensor and supplying a signal representing trapping by the window glass lifting mechanism.

16. A method for determining entrapment by a window glass lifting mechanism comprising:
providing a sliding member for a window glass;
providing a cable for driving the sliding member for the window glass and connected to the sliding member;
providing a motor for driving the cable;
providing a sensor measuring tension in said cable the method consisting in:
measuring a tension in the drive cable;
comparing the measured tension with an entrapment threshold; and
supplying a signal representing entrapment by the window glass lifting mechanism when the measured tension exceeds the threshold value.

17. The method for determining entrapment by a window glass lifting mechanism according to claim 16 further comprising the steps of:
storing in a memory for the window glass lifting mechanism a reference value as a function of a parameter such as an entrapment threshold;
measuring a tension in the window glass lifting cable as a function of that parameter; and
comparing the measured tension with the reference value for a given parameter value.

18. The method according to claim 17, wherein the value stored in memory is a function of a cable tension measured during an earlier window glass lifting cycle.

19. The method of claim 18, wherein the value stored in memory takes account of a cable tension measured during a plurality earlier window glass lifting cycles.
